(19) United States
(12) Patent Application Publication
(10) Pub. No.: US 2026/0226294 A1
(43) Pub. Date: Aug. 6, 2026

(54) ELECTRODEPOSITABLE COATING COMPOSITIONS AND METHODS OF COATING SUBSTRATES

(71) Applicant: PPG Industries Ohio, Inc., Cleveland, OH (US)

(72) Inventors: Corey James DeDomenic, Trafford, PA (US); Christophe Rene Gaston Grenier, Pittsburgh, PA (US); Lyanne Valdez, Pittsburgh, PA (US); Scott Joseph Moravek, Mars, PA (US); Reza Michael Rock, Pittsburgh, PA (US); Tanvi Siraj Ratani, Pittsburgh, PA (US); Douglas Gordon Montjoy, Pittsburgh, PA (US)

(73) Assignee: PPG Industries Ohio, Inc., Cleveland, OH (US)

(21) Appl. No.: 19/152,071

(22) PCT Filed: Feb. 1, 2024
(86) PCT No.: PCT/US2024/013996

§ 371 Date: Jul. 30, 2025

Related U.S. Application Data
(60) Provisional application No. 63/482,784, filed on Feb. 1, 2023.

(51) Int. Cl. C09D 5/44

(52) U.S. Cl. CPC C09D 5/4411; C09D 5/443

(57) ABSTRACT

The present disclosure is directed to a cationic electrodepositable coating composition comprising a cationic-salt group-containing, film-forming polymer; a polymer comprising at least one phosphorylated group; and a curing agent. Also disclosed are methods of coating substrates and coated substrate.

### FIELD

The present disclosure is directed towards an electrodepositable coating composition, coated substrates, and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods.

### SUMMARY

The present disclosure provides a cationic electrodepositable coating composition comprising: a cationic-salt group-containing, aromatic film-forming polymer; an addition polymer comprising at least one phosphorylated group and optionally at least one hydroxyl functional group, wherein the addition polymer does not include a cationic or anionic-salt group when the addition polymer comprises a (meth)acrylamide monomer, and the addition polymer comprises less than 60% by weight of constitutional units comprising the residue of a hydroxyl-functional (meth)acrylate monomer and/or a hydroxyl-functional (meth)acrylamide monomer, based on the total weight of the addition polymer; and a curing agent.

The present disclosure also provides a cationic electrodepositable coating composition comprising: a cationic-salt group-containing, film-forming polymer; an addition polymer comprising a polymerization product of a monomer composition comprising: (a) a C₁-C₁₈ alkyl (meth)acrylate monomer; and (b) a phosphorus acid-containing monomer, wherein the addition polymer does not include a cationic or anionic-salt group when the addition polymer comprises a (meth)acrylamide monomer, and the addition polymer comprises less than 60% by weight of constitutional units comprising the residue of a hydroxyl-functional (meth)acrylate monomer and/or a hydroxyl-functional (meth)acrylamide monomer, based on the total weight of the addition polymer; and a curing agent.

The present disclosure further provides a cationic electrodepositable coating composition comprising: a cationic-salt group-containing, film-forming polymer; a phosphatized epoxy resin; and a curing agent.

The present disclosure also provides a cationic electrodepositable coating composition comprising: a cationic-salt group-containing, film-forming polymer; a polymer comprising at least one phosphorylated group and optionally at least one hydroxyl functional group, wherein the polymer does not include a cationic or anionic-salt group when the polymer comprises a (meth)acrylamide monomer, and the polymer comprises less than 60% by weight of constitutional units comprising the residue of a hydroxyl-functional (meth)acrylate monomer and/or a hydroxyl-functional (meth)acrylamide monomer, based on the total weight of the polymer; a curing agent; and a pigment, wherein the pigment-to-binder ratio is greater than 0.5:1, such as at least 0.60:1, such as at least 0.70:1, such as at least 0.75:1, such as at least 1:1, such as at least 1.25:1, such as at least 1.5:1.

The present disclosure further provides a cationic electrodepositable coating composition comprising: a cationic-salt group-containing, film-forming polymer; a polymer comprising at least one phosphorylated group and optionally at least one hydroxyl functional group, wherein the polymer does not include a cationic or anionic-salt group when the polymer comprises a (meth)acrylamide monomer, and the polymer comprises less than 60% by weight of constitutional units comprising the residue of a hydroxyl-functional (meth)acrylate monomer and/or a hydroxyl-functional (meth)acrylamide monomer, based on the total weight of the polymer; a curing agent; and a pigment, wherein the pigment-to-binder ratio is greater than 0.67:1, such as at least 0.70:1, such as at least 0.75:1, such as at least 1:1, such as at least 1.25:1, such as at least 1.5:1.

The present disclosure also provides a cationic electrodepositable coating composition comprising: a cationic-salt group-containing, film-forming polymer; a polymer comprising at least one phosphorylated group and optionally at least one hydroxyl functional group, wherein the polymer does not include a cationic-salt group when the polymer comprises a (meth)acrylamide monomer; a curing agent; and an inorganic, plate-like pigment, wherein the inorganic, plate-like pigment-to-binder ratio is at least 0.4:1, such as at least 0.5:1, such as at least 0.60:1, such as at least 0.70:1, such as at least 0.75:1, such as at least 1:1, such as at least 1.25:1, such as at least 1.5:1.

The present disclosure further provides a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as a cathode in electrical communication with an anode immersed in the cationic electrodepositable coating composition; (2) allowing the immersed metal substrate to dwell in the cationic electrodepositable coating composition for a period of time, whereby a metal phosphate layer forms over at least a portion of the surface of the metal substrate; and (3) applying a direct electrical current between the cathode and the anode whereby a coating is deposited onto the surface of the metal substrate from the cationic electrodepositable coating composition.

The present disclosure also provides a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as an electrode in electrical communication with a counter-electrode immersed in the cationic electrodepositable coating composition; (2) applying a direct electrical current between the electrode and the counter-electrode wherein the electrode serves as the anode and the counter-electrode serves as the cathode, whereby a metal phosphate layer forms over at least a portion of the surface of the metal substrate; and (3) applying a direct electrical current between the electrode and the counter-electrode wherein the polarity is reversed and the electrode serves as the cathode and the counter-electrode serves as the anode, whereby a coating is deposited onto the surface of the metal substrate from the cationic electrodepositable coating composition.

The present disclosure further provides a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as an electrode in electrical communication with a counter-electrode immersed in the cationic electrodepositable coating composition; and (2) applying a direct electrical current between the electrode and the counter-electrode wherein the electrode serves as the cathode and the counter-electrode serves as the anode, whereby a coating is deposited onto the surface of the metal substrate from the cationic electrodepositable coating composition; wherein the metal substrate is not treated with a pretreatment composition prior to being immersed in the cationic electrodepositable coating composition.

### DETAILED DESCRIPTION

The present disclosure is directed to a cationic electrodepositable coating composition comprising a cationic-salt group-containing, film-forming polymer; a polymer comprising at least one phosphorylated group; and a curing agent.

As used herein, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

The cationic electrodepositable coating composition comprises a polymer comprising at least one phosphorylated group. The polymer is not limited. Non-limiting examples of the polymer include an addition polymer comprising at least one phosphorylated group, a phosphatized epoxy resin, as well as other polymers comprising at least one phosphorylated group.

As used herein, the term “phosphorylated group” and “phosphorus acid group” refers to a phosphate group attached to the polymer. As used herein, “phosphate” refers to anions derived from phosphoric acid having the general chemical formula [PO₄]³⁻, [HPO₄]²⁻, and/or [H₂PO₄]⁻. Although reference herein is to “phosphate” ions, derivatives of other phosphorus acid derivatives are within the scope of the disclosure. Accordingly, unless specified otherwise, the phosphate ions may refer to phosphonate anions derived from phosphonic acid having the general chemical formula [RPO₃]²⁻ and/or [RHPO₃]¹⁻, and phosphinate anions derived from phosphinic acid.

The polymer may have a phosphorus acid equivalent weight of at least 0.01 milliequivalents per gram of polymer, such as at least 0.05, such as at least 0.1, such as at least 1, such as at least 2, such as at least 4. The polymer may have a phosphorus acid equivalent weight of no more than 10 milliequivalents per gram of polymer, such as no more than 7, such as no more than 5, such as no more than 3, such as no more than 2, such as no more than 1. The polymer may have a phosphorus acid equivalent weight of 0.01 to 10 milliequivalents per gram of polymer, such as 0.01 to 7, such as 0.01 to 5, such as 0.01 to 3, such as 0.01 to 2, such as 0.01 to 1, such as 0.05 to 10, such as 0.05 to 7, such as 0.05 to 5, such as 0.05 to 3, such as 0.05 to 2, such as 0.05 to 1, such as 0.1 to 10, such as 0.1 to 7, such as 0.1 to 5, such as 0.1 to 3, such as 0.1 to 2, such as 0.1 to 1, such as 1 to 10, such as 1 to 7, such as 1 to 5, such as 1 to 3, such as 1 to 2, such as 2 to 10, such as 2 to 7, such as 2 to 5, such as 2 to 3, such as 4 to 10, such as 4 to 7, such as 4 to 5. The phosphorus acid equivalent weight may be determined by dividing the total weight of the polymer by the total number of phosphorus acid groups present in the polymer.

The polymer comprising at least one phosphorylated group may comprise an addition polymer. As used herein, the term “addition polymer” refers to a polymerization product formed by the polymerization reaction of monomers comprising a monomer composition to form a polymer. Following polymerization of the monomers of the monomer composition, the addition polymer comprising constitutional units corresponding to the residue of each polymerized monomer. As used herein, the term “residue of” when referring to the composition of a polymer refers to a singular molecular unit (i.e., constitutional unit) within the polymer that results from incorporation (i.e., reaction) of a monomer during polymerization. The addition polymer is formed by polymerizing a monomer composition that includes ethylenically unsaturated monomers.

The monomer composition comprises a phosphorus acid-functional monomer. The phosphorus acid group may comprise a phosphonic acid group, a phosphinic acid group, or combinations thereof, as well as salts thereof. The phosphorus acid-functional ethylenically unsaturated monomer may be dihydrogen phosphate esters of an alcohol in which the alcohol contains or is substituted with a polymerizable vinyl or olefinic group. Suitable phosphorus acid-functional ethylenically unsaturated monomer may include phosphoalkyl (meth)acrylates such as phosphoethyl (meth)acrylate, phosphopropyl (meth)acrylate, phosphobutyl (meth)acrylate, salts of phosphoalkyl (meth)acrylates, and mixtures thereof; CH₂═C(R)—C(O)—O—(RₚO)ₙ—P(O)(OH)₂, wherein R═H or CH₃ and Rₚ=alkyl, n is from 1 to 20, such as SIPOMER PAM-100, SIPOMER PAM-200, SIPOMER PAM-300, and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho dipropylene glycol (meth)acrylate, phospho tri-propylene glycol (meth)acrylate, salts thereof, and mixtures thereof. The phosphorus acid-functional monomer may be present in the monomer composition in an amount of at least 0.1% by weight, such as at least 1% by weight, such as at least 2% by weight, based on the total weight of the monomer composition. The phosphorus acid-functional monomer may be present in the monomer composition in an amount of no more than 20% by weight, such as no more than 10% by weight, such as no more than 8% by weight, based on the total weight of the monomer composition. The phosphorus acid-functional monomer may be present in the monomer composition in an amount of 0.1% to 20% by weight, such as 0.1% to 10% by weight, such as 0.1% to 8% by weight, such as 1% to 20% by weight, such as 1% to 10% by weight, such as 1% to 8% by weight, such as 2% to 20% by weight, such as 2% to 10% by weight, such as 2% to 8% by weight, based on the total weight of the monomer composition.

The monomer composition, and resulting addition polymer, further comprise at least one other ethylenically unsaturated monomer, or the residue thereof. For example, the monomer composition and resulting addition polymer may further comprise a C₁-C₁₈ alkyl (meth)acrylate monomer; a hydroxyl-functional (meth)acrylate monomer; a vinyl aromatic compound; a monomer comprising two or more ethylenically unsaturated groups per molecule; a (meth)acrylamide monomer; a monoalkyl (meth)acrylamide monomer; a dialkyl (meth)acrylamide monomer; and/or a hydroxyl-functional (meth)acrylamide monomer.

As used herein, “(meth)acrylate” or “(meth)acrylamide” and like terms encompasses both acrylates and methacrylates or acrylamides and methacrylamides, respectively.

The hydroxyl-functional (meth)acrylate may comprise a hydroxyalkyl (meth)acrylate, such as, for example, hydroxymethyl (meth)acrylate, hydroxyethyl (meth)acrylate, hydroxypropyl (meth)acrylate, hydroxybutyl (meth)acrylate, hydroxypentyl (meth)acrylate, and the like, as well as combinations thereof. The hydroxyl-functional (meth)acrylate may be present in the monomer composition in an amount of at least 1% by weight, such as at least 5% by weight, such as at least 10% by weight, such as at least 20% by weight, such as at least 30% by weight, based on the total weight of the monomer composition. The hydroxyl-functional (meth)acrylate may be present in the monomer composition in an amount of less than 60% by weight, such as no more than 50% by weight, such as no more than 40% by weight, based on the total weight of the monomer composition. The hydroxyl-functional (meth)acrylate may be present in the monomer composition in an amount of 1% to less than 60% by weight, such as 1% to 55% by weight, such as 1% to 50% by weight, such as 1% to 40% by weight, such as 5% to less than 60% by weight, such as 5% to 55% by weight, such as 5% to 50% by weight, such as 5% to 40% by weight, such as 10% to less than 60% by weight, such as 10% to 55% by weight, such as 10% to 50% by weight, such as 10% to 40% by weight, such as 20% to less than 60% by weight, such as 20% to 55% by weight, such as 20% to 50% by weight, such as 20% to 40% by weight, such as 30% to less than 60% by weight, such as 30% to 55% by weight, such as 30% to 50% by weight, such as 30% to 40% by weight, based on the total weight of the monomer composition.

The hydroxyl-functional (meth)acrylamide monomer may comprise a hydroxyalkyl (meth)acrylamide, such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, and the like, as well as combinations thereof. The hydroxyl-functional (meth)acrylamide monomer may be present in the monomer composition in an amount of at least 1% by weight, such as at least 5% by weight, such as at least 10% by weight, such as at least 20% by weight, such as at least 30% by weight, based on the total weight of the monomer composition. The hydroxyl-functional (meth)acrylamide monomer may be present in the monomer composition in an amount of less than 60% by weight, such as no more than 50% by weight, such as no more than 40% by weight, based on the total weight of the monomer composition. The hydroxyl-functional (meth)acrylamide monomer may be present in the monomer composition in an amount of 1% to less than 60% by weight, such as 1% to 55% by weight, such as 1% to 50% by weight, such as 1% to 40% by weight, such as 5% to less than 60% by weight, such as 5% to 55% by weight, such as 5% to 50% by weight, such as 5% to 40% by weight, such as 10% to less than 60% by weight, such as 10% to 55% by weight, such as 10% to 50% by weight, such as 10% to 40% by weight, such as 20% to less than 60% by weight, such as 20% to 55% by weight, such as 20% to 50% by weight, such as 20% to 40% by weight, such as 30% to less than 60% by weight, such as 30% to 55% by weight, such as 30% to 50% by weight, such as 30% to 40% by weight, based on the total weight of the monomer composition.

In examples, the addition polymer may comprise less than 60% by weight of constitutional units comprising the residue of a hydroxyl-functional (meth)acrylate monomer and/or a hydroxyl-functional (meth)acrylamide monomer, based on the total weight of the addition polymer.

When the hydroxyl-functional (meth)acrylate monomer and/or a hydroxyl-functional (meth)acrylamide monomer are present, the addition polymer comprises hydroxyl functional groups. The addition polymer may have a hydroxyl value of at least 1, such as at least 10 mg KOH/g, such as at least 20 mg KOH/g, such as at least 50 mg KOH/g, such as at least 100 mg KOH/g. The addition polymer may have a hydroxyl value of no more than 500 mg KOH/g, such as no more than 300 mg KOH/g, such as no more than 200 mg KOH/g. The addition polymer may have a hydroxyl value of 1 to 500 mg KOH/g, such as 1 to 300 mg KOH/g, such as 1 to 200 mg KOH/g, such as 10 to 500 mg KOH/g, such as 10 to 300 mg KOH/g, such as 10 to 200 mg KOH/g, such as 20 to 500 mg KOH/g, such as 20 to 300 mg KOH/g, such as 20 to 200 mg KOH/g, such as 50 to 500 mg KOH/g, such as 50 to 300 mg KOH/g, such as 50 to 200 mg KOH/g, such as 100 to 500 mg KOH/g, such as 100 to 300 mg KOH/g, such as 100 to 200 mg KOH/g. As used herein, the term “hydroxyl value” typically refers to the number of milligrams of potassium hydroxide (KOH) required to neutralize the acetic acid taken up on acetylation of one gram of a chemical substance that contains free hydroxyl groups and was herein determined by a theoretical calculation of the number of free hydroxyl groups theoretically present in one gram of the addition polymer.

Examples of suitable C₁-C₁₈ alkyl (meth)acrylates include, without limitation, methyl (meth)acrylate, ethyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, isobornyl (meth)acrylate, t-butyl (meth)acrylate, and the like. The C₁-C₁₈ alkyl (meth)acrylates may be present in the monomer composition in an amount of at least 30% by weight, such as at least 40% by weight, such as at least 50% by weight, such as at least 60% by weight, such as at least 70% by weight, based on the total weight of the monomer composition. The C₁-C₁₈ alkyl (meth)acrylates may be present in the monomer composition in an amount of no more than 90% by weight, such as no more than 80% by weight, such as no more than 70% by weight, such as no more than 60% by weight, based on the total weight of the monomer composition. The C₁-C₁₈ alkyl (meth)acrylates may be present in the monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the monomer composition.

Non-limiting examples of suitable vinyl aromatic compounds include styrene, alpha-methyl styrene, alpha-chloromethyl styrene and/or vinyl toluene. The vinyl aromatic compound may be present in the monomer composition in an amount of at least 0.5% by weight, such as at least 1% by weight, such as at least 5% by weight, such as at least 10% by weight, based on the total weight of the monomer composition. The vinyl aromatic compound may be present in the monomer composition in an amount of no more than 40% by weight, such as no more than 30% by weight, such as no more than 20% by weight, such as no more than 15% by weight, such as no more than 10% by weight, based on the total weight of the monomer composition. The vinyl aromatic compound may be present in the monomer composition in an amount of 0.5% to 40% by weight, such as 0.5% to 30% by weight, such as 0.5% to 20% by weight, such as 0.5% to 15% by weight, such as 0.5% to 10% by weight, such as 1% to 40% by weight, such as 1% to 30% by weight, such as 1% to 20% by weight, such as 1% to 15% by weight, such as 1% to 10% by weight, such as 5% to 40% by weight, such as 5% to 30% by weight, such as 5% to 20% by weight, such as 5% to 15% by weight, such as 5% to 10% by weight, such as 10% to 40% by weight, such as 10% to 30% by weight, such as 10% to 20% by weight, such as 10% to 15% by weight, based on the total weight of the monomer composition.

Examples of suitable monomers having two ethylenically unsaturated groups per molecule include ethylene glycol dimethacrylate, allyl methacrylate, hexanediol diacrylate, methacrylic anhydride, tetraethylene glycol diacrylate, and/or tripropylene glycol diacrylate. Examples of monomers having three or more ethylenically unsaturated groups per molecule include ethoxylated trimethylolpropane triacrylate having 0 to 20 ethoxy units, [ethoxylated]trimethylolpropane trimethacrylate having 0 to 20 ethoxy units, di-pentaerythritoltriacrylate, pentaerythritol tetraacrylate, and/or di-pentaerythritolpentaacrylate. The monomer comprising two or more ethylenically unsaturated groups per molecule may be present in the monomer composition in an amount of at least 0.1% by weight, such as at least 1% by weight, such as at least 3% by weight, such as at least 5% by weight, based on the total weight of the monomer composition. The monomer comprising two or more ethylenically unsaturated groups per molecule may be present in the monomer composition in an amount of no more than 10% by weight, such as no more than 5% by weight, such as no more than 3% by weight, based on the total weight of the monomer composition. The monomer comprising two or more ethylenically unsaturated groups per molecule may be present in the monomer composition in an amount of 0.1% to 10% by weight, such as 0.1% to 5% by weight, such as 0.1% to 3% by weight, such as 1% to 10% by weight, such as 1% to 5% by weight, such as 1% to 3% by weight, such as 3% to 10% by weight, such as 3% to 5% by weight, such as 5% to 10% by weight, based on the total weight of the monomer composition.

Examples of suitable alkyl (meth)acrylamide monomers include CI-Cis alkyl (meth)acrylamide monomers such as, without limitation, methyl (meth)acrylamide, ethyl (meth)acrylamide, butyl (meth)acrylamide, hexyl (meth)acrylamide, octyl (meth)acrylamide, isodecyl (meth)acrylamide, stearyl (meth)acrylamide, 2-ethylhexyl (meth)acrylamide, isobornyl (meth)acrylamide, t-butyl (meth)acrylamide, and the like. The alkyl (meth)acrylamide monomer may be present in the monomer composition in an amount of at least 30% by weight, such as at least 40% by weight, such as at least 50% by weight, such as at least 60% by weight, such as at least 70% by weight, based on the total weight of the monomer composition. The alkyl (meth)acrylamide monomer may be present in the monomer composition in an amount of no more than 90% by weight, such as no more than 80% by weight, such as no more than 70% by weight, such as no more than 60% by weight, based on the total weight of the monomer composition. The alkyl (meth)acrylamide monomer may be present in the monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the monomer composition.

The monomer composition optionally may comprise a monomer comprising two or more ethylenically unsaturated groups per molecule. The monomer comprising two or more ethylenically unsaturated groups per molecule may comprise a monomer having two ethylenically unsaturated groups per molecule. Examples of suitable monomers having two ethylenically unsaturated groups per molecule include ethylene glycol dimethacrylate, allyl methacrylate, hexanediol diacrylate, methacrylic anhydride, tetraethylene glycol diacrylate, and/or tripropylene glycol diacrylate. Examples of monomers having three or more ethylenically unsaturated groups per molecule include ethoxylated trimethylolpropane triacrylate having 0 to 20 ethoxy units, [ethoxylated]trimethylolpropane trimethacrylate having 0 to 20 ethoxy units, di-pentaerythritoltriacrylate, pentaerythritol tetraacrylate, and/or di-pentaerythritolpentaacrylate. The monomer comprising two or more ethylenically unsaturated groups per molecule may be present in the monomer composition in an amount of at least 0.1% by weight, such as at least 1% by weight, such as at least 3% by weight, such as at least 5% by weight, based on the total weight of the monomer composition. The monomer comprising two or more ethylenically unsaturated groups per molecule may be present in the monomer composition in an amount of no more than 10% by weight, such as no more than 5% by weight, such as no more than 3% by weight, based on the total weight of the monomer composition. The monomer comprising two or more ethylenically unsaturated groups per molecule may be present in the monomer composition in an amount of 0.1% to 10% by weight, such as 0.1% to 5% by weight, such as 0.1% to 3% by weight, such as 1% to 10% by weight, such as 1% to 5% by weight, such as 1% to 3% by weight, such as 3% to 10% by weight, such as 3% to 5% by weight, such as 5% to 10% by weight, based on the total weight of monomer composition.

The addition polymer may be prepared via polymerization of an ethylenically unsaturated polymerizable monomer composition in a dispersing medium comprising water by techniques well known in the art. For example, the monomer composition may be dissolved or dispersed in water and subjected to addition polymerization conditions by heating in the presence of a free radical initiator. The monomer composition may optionally comprise a surfactant to assist in dispersing the monomer composition, and the surfactant may be a reactive surfactant or an unreactive surfactant. Alternatively, the monomer composition may be substantially free, essentially free, or completely free of reactive and/or unreactive surfactant. The time and temperature of polymerization will depend on one another, the ingredients selected and, in some cases, the scale of the reaction. The polymerization may be conducted at, for example, 40° C. to 100° C. for 2 to 20 hours. The free radical initiator utilized for the polymerization may be selected from any of those used for aqueous latex polymerization techniques, including redox pair initiators, peroxides, hydroperoxides, peroxydicarbonates, azo compounds and the like.

The addition polymer may be prepared in organic solution by techniques well known in the art. For example, the addition polymer may be prepared by conventional free radical initiated solution polymerization techniques wherein the monomer composition is dissolved in a solvent or a mixture of solvents and polymerized in the presence of a free radical initiator. Examples of suitable solvents which may be used for organic solution polymerization include alcohols, such as ethanol, tertiary butanol, and tertiary amyl alcohol; ketones, such as acetone, methyl ethyl ketone; and ethers, such as dimethyl ether of ethylene glycol. Examples of suitable free radical initiators include those which are soluble in the mixture of monomers, such as azobisisobutyronitrile, 2,2′-azobis(2-methylbutyronitrile), azobis-(alpha, gamma-dimethylvaleronitrile), tertiary-butyl perbenzoate, tertiary-butyl peracetate, benzoyl peroxide, and ditertiary-butyl peroxide. The free radical initiator may be present in an amount of 0.01% to 6% by weight, such as 1.0% to 4.0% by weight, such as 2.0% to 3.5% by weight, based on the total weight of the monomer composition. In examples, the solvent may be first heated to reflux and a mixture of the monomer composition and a free radical initiator may be added slowly to the refluxing solvent. The reaction mixture may be held at polymerizing temperatures so as to reduce the free monomer content to below 1.0%, such as below 0.5% by weight, based on the total weight of the monomer composition.

Ionic salt-groups in the addition polymer, if present, may be formed by at least partially neutralizing basic or acidic groups present in the acrylic polymer with an acid or base, respectively. The ionic groups in the polymer may be charge neutralized by counter-ions. Ionic groups and charge neutralizing counter-ions may together form salt groups, such that the addition polymer may comprise an ionic salt group-containing acrylic polymer.

Alternatively, the addition polymer does not include a cationic or anionic-salt group. For example, the addition polymer may be free of a cationic and/or anionic-salt group when the addition polymer comprises a (meth)acrylamide monomer.

The addition polymer may be substantially free, essentially free, or completely free of constitutional units comprising the residue of vinyl alcohol. As used herein, the addition polymer is “substantially free” of constitutional units comprising the residue of vinyl alcohol if constitutional units comprising the residue of vinyl alcohol are present in the addition polymer, if at all, in an amount of less than 3% by weight, based on the total weight of the addition polymer. As used herein, the addition polymer is “essentially free” of constitutional units comprising the residue of vinyl alcohol if constitutional units comprising the residue of vinyl alcohol are present in the addition polymer, if at all, in an amount of less than 1% by weight, based on the total weight of the addition polymer. As used herein, the acrylic polymer is “completely free” of constitutional units comprising the residue of vinyl alcohol if constitutional units comprising the residue of vinyl alcohol are not present in the addition polymer, i.e., 0% by weight. As used herein, “vinyl alcohol” refers to both vinyl alcohol monomers as well as vinyl esters that are hydrolyzed after polymerization to convert the ester to a hydroxyl group.

The addition polymer may be substantially free, essentially free, or completely free of constitutional units comprising the residue of nitrogen-containing monomers. As used herein, the addition polymer is “substantially free” of constitutional units comprising the residue of nitrogen-containing monomers if constitutional units comprising the residue of nitrogen-containing monomers are present in the addition polymer, if at all, in an amount of less than 3% by weight, based on the total weight of the addition polymer. As used herein, the addition polymer is “essentially free” of constitutional units comprising the residue of nitrogen-containing monomers if constitutional units comprising the residue of nitrogen-containing monomers are present in the addition polymer, if at all, in an amount of less than 1% by weight, based on the total weight of the addition polymer. As used herein, the addition polymer is “completely free” of constitutional units comprising the residue of nitrogen-containing monomers if constitutional units comprising the residue of nitrogen-containing monomers are not present in the addition polymer, i.e., 0% by weight.

The addition polymer may be substantially free, essentially free, or completely free of constitutional units comprising the residue of a polymeric dispersant. As used herein, the addition polymer is “substantially free” of constitutional units comprising the residue of a polymeric dispersant if constitutional units comprising the residue of the polymeric dispersant is present in the addition polymer, if at all, in an amount of less than 15% by weight, based on the total weight of the addition polymer. As used herein, the addition polymer is “essentially free” of constitutional units comprising the residue of a polymeric dispersant if constitutional units comprising the residue of the polymeric dispersant is present in the addition polymer, if at all, in an amount of less than 5% by weight, based on the total weight of the addition polymer. As used herein, the addition polymer is “completely free” of constitutional units comprising the residue of a polymeric dispersant if constitutional units comprising the residue of the polymeric dispersant is not present in the addition polymer, i.e., 0% by weight.

The addition polymer may be substantially free, essentially free, or completely free of constitutional units comprising the residue of diene monomers. As used herein, the addition polymer is “substantially free” of constitutional units comprising the residue of diene monomers if constitutional units comprising the residue of diene monomers is present in the addition polymer, if at all, in an amount of less than 2% by weight, based on the total weight of the addition polymer. As used herein, the addition polymer is “essentially free” of constitutional units comprising the residue of diene monomers if constitutional units comprising the residue of diene monomers is present in the addition polymer, if at all, in an amount of less than 0.1% by weight, based on the total weight of the addition polymer. As used herein, the addition polymer is “completely free” of constitutional units comprising the residue of diene monomers if constitutional units comprising the residue of diene monomers is not present in the addition polymer, i.e., 0.0% by weight.

The addition polymer may be substantially free, essentially free, or completely free of constitutional units comprising the residue of isobutylene monomers. As used herein, the addition polymer is “substantially free” of constitutional units comprising the residue of isobutylene monomers if constitutional units comprising the residue of isobutylene monomers is present in the addition polymer, if at all, in an amount of less than 2% by weight, based on the total weight of the addition polymer. As used herein, the addition polymer is “essentially free” of constitutional units comprising the residue of isobutylene monomers if constitutional units comprising the residue of isobutylene monomers is present in the addition polymer, if at all, in an amount of less than 0.1% by weight, based on the total weight of the addition polymer. As used herein, the addition polymer is “completely free” of constitutional units comprising the residue of isobutylene monomers if constitutional units comprising the residue of isobutylene monomers is not present in the addition polymer, i.e., 0.0% by weight.

The addition polymer may be substantially free, essentially free, or completely free of the residue of monomers comprising three or more ethylenically unsaturated groups per molecule. As used herein, the addition polymer is “substantially free” of constitutional units comprising the residue of monomers comprising three or more ethylenically unsaturated groups per molecule if constitutional units comprising the residue of monomers comprising three or more ethylenically unsaturated groups per molecule are present in the addition polymer, if at all, in an amount of less than 0.1% by weight, based on the total weight of the addition polymer. As used herein, the addition polymer is “essentially free” of constitutional units comprising the residue of monomers comprising three or more ethylenically unsaturated groups per molecule if constitutional units comprising the residue of monomers comprising three or more ethylenically unsaturated groups per molecule is present in the addition polymer, if at all, in an amount of less than 0.01% by weight, based on the total weight of the addition polymer. As used herein, the addition polymer is “completely free” of constitutional units comprising the residue of monomers comprising three or more ethylenically unsaturated groups per molecule if constitutional units comprising the residue of monomers comprising three or more ethylenically unsaturated groups per molecule is not present in the addition polymer, i.e., 0.00% by weight.

The addition polymer may be substantially free, essentially free, or completely free of silicon. As used herein, “silicon” refers to elemental silicon or any silicon containing compound, such as an organosilicon compound including an alkoxysilane. As used herein, the addition polymer is “substantially free” of silicon if silicon is present in the addition polymer in an amount of less than 2% by weight, based on the total weight of the addition polymer. As used herein, the addition polymer is “essentially free” of silicon if silicon is present in the addition polymer in an amount of less than 1% by weight, based on the total weight of the addition polymer. As used herein, the addition polymer is “completely free” of silicon if silicon is not present in the addition polymer, i.e., 0% by weight.

The polymer comprising at least one phosphorylated group may comprise a phosphatized epoxy resin. As used herein, the term “phosphatized epoxy resin” refers to an ungelled resin derived from at least a polyepoxide and a phosphorus acid and specifically excludes addition polymers such as (meth)acrylic polymers. The polyepoxide may comprise a polyglycidyl ether of a polyphenol, such as bisphenol A, such that the phosphatized epoxy resin is an aromatic phosphatized epoxy resin. Exemplary aromatic phosphatized epoxy resins are provided in U.S. Pat. Application Publication No. 2009/0045071 at [0004]-[0015] and U.S. patent application Ser. No. 13/232,093 at [0014]-[0040], the cited portions of which being incorporated herein by reference. Alternatively, the phosphatized epoxy may be an aliphatic phosphatized epoxy resin that is not an addition polymer. Polyesters, polyurethanes, polyethers, or polyamides prepared with glycidyl alcohols or glycidyl amines, or reacted with an epihalohydrin are also suitable epoxy functional resins. Epoxide functional groups may be incorporated into an aliphatic resin by reacting hydroxyl groups on the resin with an epihalohydrin or dihalohydrin such as epichlorohydrin or dichlorohydrin in the presence of alkali. The aliphatic epoxy resin may then be reacted with the phosphorus acid.

The polymer comprising at least one phosphorylated group may have a hydroxyl value of at least 1, such as at least 10 mg KOH/g, such as at least 20 mg KOH/g, such as at least 50 mg KOH/g, such as at least 100 mg KOH/g, such as at least 200 mg KOH/g. The polymer may have a hydroxyl value of no more than 600 mg KOH/g, such as no more than 500 mg KOH/g, such as no more than 300 mg KOH/g, such as no more than 200 mg KOH/g. The polymer may have a hydroxyl value of 1 to 600 mg KOH/g, such as 1 to 500 mg KOH/g, such as 1 to 300 mg KOH/g, such as 1 to 200 mg KOH/g, such as 10 to 600 mg KOH/g, such as 10 to 500 mg KOH/g, such as 10 to 300 mg KOH/g, such as 10 to 200 mg KOH/g, such as 20 to 600 mg KOH/g, such as 20 to 500 mg KOH/g, such as 20 to 300 mg KOH/g, such as 20 to 200 mg KOH/g, such as 50 to 600 mg KOH/g, such as 50 to 500 mg KOH/g, such as 50 to 300 mg KOH/g, such as 50 to 200 mg KOH/g, such as 100 to 600 mg KOH/g, such as 100 to 500 mg KOH/g, such as 100 to 300 mg KOH/g, such as 100 to 200 mg KOH/g, such as 200 to 600 mg KOH/g, such as 200 to 500 mg KOH/g, such as 200 to 300 mg KOH/g.

The polymer comprising at least one phosphorylated group may be present in the cationic electrodepositable coating composition in an amount of at least 0.01% by weight, such as at least 1% by weight, such as at least 5% by weight, such as at least 10% by weight, based on the total weight of resin solids. The polymer comprising at least one phosphorylated group may be present in the cationic electrodepositable coating composition in an amount of no more than 50% by weight, such as no more than 30% by weight, such as no more than 20% by weight, such as no more than 15% by weight, based on the total weight of resin solids. The polymer comprising at least one phosphorylated group may be present in the cationic electrodepositable coating composition in an amount of 0.01% to 50% by weight, 0.01% to 30% by weight, such as 0.01% to 20% by weight, such as 0.01% to 15% by weight, such as 1% to 50% by weight, 1% to 30% by weight, such as 1% to 20% by weight, such as 1% to 15% by weight, such as 5% to 50% by weight, 5% to 30% by weight, such as 5% to 20% by weight, such as 5% to 15% by weight, such as 10% to 50% by weight, 10% to 30% by weight, such as 10% to 20% by weight, such as 10% to 15% by weight, based on the total weight of resin solids.

The cationic electrodepositable coating composition may comprise any suitable cationic electrodepositable binder. For example, the cationic electrodepositable binder may comprise an organic or inorganic electrodepositable binder.

As used herein, an “organic” electrodepositable binder comprises at least 50% by weight of organic-based materials, based on the total weight of the electrodepositable binder, such as at least 51% by weight, such as at least 75% by weight, such as at least 85% by weight, such as at least 95% by weight, such as at least 99% by weight, and may be 100% by weight. The organic film-forming binder may comprise 51% to 100% by weight of organic-based materials, such as 75% to 100% by weight, such as 85% to 100% by weight, such as 95% to 100% by weight, such as 99% to 100% by weight, such as 100% by weight, based on the total weight of the electrodepositable binder. The remainder of the binder may comprise inorganic materials present in an amount of less than 50% by weight, based on the total weight of the electrodepositable binder. The term “organic-based material” refers to carbon-based materials such as the organic film-forming resins and organic curing agents described herein.

In contrast, as used herein, an “inorganic” electrodepositable binder comprises less than 50% by weight of organic-based materials, based on the total weight of the electrodepositable binder, such as less than 25% by weight, such as less than 15% by weight, such as less than 5% by weight, such as less than 1% by weight, and may be 0% by weight. The inorganic electrodepositable binder may comprise inorganic-based materials in an amount of 51% to 100% by weight, such as 75% to 100% by weight, such as 85% to 100% by weight, such as 95% to 100% by weight, such as 99% to 100% by weight, such as 100% by weight, based on the total weight of the electrodepositable binder.

The cationic electrodepositable binder may be derived from, and the cationic electrodepositable coating composition may comprise, a cationic-salt group-containing, film-forming polymer. The cationic-salt group-containing, film-forming polymer may comprise an active hydrogen-containing, cationic salt group-containing, film-forming polymer.

In examples, the cationic-salt group-containing, film-forming polymer may comprise a cationic-salt group-containing, aromatic film-forming polymer. As used herein, “aromatic” refers to a hydrocarbon having a delocalized conjugated Tr-system with alternating double and single bonds between carbon atoms forming one or more coplanar hydrocarbon rings within the backbone of the polymeric chain. For example, the cationic-salt group-containing, aromatic film-forming polymer may be at least partially derived from an aromatic compound such as a bisphenol or a diglycidyl ether of a bisphenol, such as bisphenol A, bisphenol S, and/or bisphenol F or a diglycidyl ether thereof, a novolac resin, di- or polyglycidyl ethers of an alkylated phenols described below, and/or diglycidyl ethers of a dihydroxy benzene such as catechol, resorcinol, or hydroquinone. In contrast, acrylic polymers comprising the residue of styrene wherein the aromatic group is present in a sidechain of the acrylic polymer and not part of the polymeric chain backbone are not considered to be an “aromatic” film-forming polymer.

When present, the cationic-salt group-containing, aromatic film-forming polymer may be present in the cationic electrodepositable coating composition, and resulting electrodeposited coating, in an amount of at least 10% by weight, based on the total weight of the resin solids, such as at least 20% by weight, such as at least 30% by weight, such as at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition, and resulting electrodepositable coating, in an amount of no more than 90% by weight, such as no more than 80% by weight, such as no more than 75% by weight, such as no more than 60% by weight, such as no more than 50% by weight, such as no more than 40% by weight, such as no more than 30% by weight, based on the total weight of the resin solids of the electrodepositable coating composition. The cationic salt group-containing film-forming polymer may be present in the cationic electrodepositable coating composition, and resulting electrodepositable coating, in an amount of 10% to 90% by weight, such as 10% to 80% by weight, such as 10% to 75% by weight, such as 10% to 60% by weight, such as 10% to 50% by weight, such as 20% to 90% by weight, such as 20% to 80% by weight, such as 20% to 75% by weight, such as 20% to 60% by weight, such as 20% to 50% by weight, such as 30% to 90% by weight, such as 30% to 80% by weight, such as 30% to 75% by weight, such as 30% to 60% by weight, such as 30% to 50% by weight, such as 40% to 90% by weight, such as 40% to 80% by weight, such as 40% to 75% by weight, such as 40% to 60% by weight, such as 40% to 50% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. The term “active hydrogen” refers to hydrogens which, because of their position in the molecule, display activity according to the Zerewitinoff test, as described in the JOURNAL OF THE AMERICAN CHEMICAL SOCIETY, Vol. 49, page 3181 (1927). Accordingly, active hydrogens include hydrogen atoms attached to oxygen, nitrogen, or sulfur, and thus active hydrogen functional groups include, for example, hydroxyl, thiol, carbamate, primary amino, and/or secondary amino groups (in any combination). Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs [0096] to [0123], this portion of which being incorporated herein by reference.

The cationic salt group-containing film-forming polymer may optionally comprise a reaction product of a reaction mixture comprising (a) an aromatic polyepoxide; (b) di-functional chain extender; and (c) a mono-functional reactant. Non-limiting examples of such polymers are provided in Int'l App. No. PCT/US22/73356, at paragraphs [0023] to [0038], the cited portion of which is incorporated herein by reference.

Non-limiting examples of inorganic electrodepositable film-forming polymers include silicone-based film-forming polymers. Non-limiting examples of such polymers are described in Int'l Pub. No. WO 2021/138384 A1, at paragraphs [0007] through [0029], the cited portion of which is incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

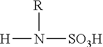

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition, and resulting electrodeposited coating, in an amount of at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition, and resulting electrodepositable coating, in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition, and resulting electrodepositable coating, in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

As used herein, the “resin solids” include the cationic salt group-containing film-forming polymer, the polymer comprising at least one phosphorylated group, such as the addition polymer or phosphatized epoxy resin, the curing agent, and any additional water-dispersible non-pigmented component(s) present in the electrodepositable coating composition.

The electrodepositable coating composition of the present disclosure may further comprise a curing agent. The curing agent may react with the reactive groups, such as active hydrogen groups, of the cationic salt group-containing film-forming polymer as well as any reactive groups, if present, of any additional resinous materials, to effectuate cure of the electrodepositable coating composition to form a coating. Non-limiting examples of suitable curing agents include at least partially blocked polyisocyanates, as well as aminoplast resins, and/or phenoplast resins, such as phenolformaldehyde condensates including allyl ether derivatives thereof.

As used herein, the term “cure”, “cured” or similar terms, as used in connection with the electrodepositable coating compositions described herein, means that at least a portion of the components that form the electrodepositable coating composition are crosslinked to form a crosslinked coating. Additionally, curing of the electrodepositable coating composition refers to subjecting the electrodeposited composition to curing conditions (e.g., elevated temperature) leading to the reaction of the reactive functional groups of the components of the electrodepositable coating composition, and resulting in the crosslinking of the components of the composition and formation of an at least partially cured coating. As used herein, the term “at least partially cured” with respect to a coating refers to a coating formed by subjecting the coating composition to curing conditions such that a chemical reaction of at least a portion of the reactive groups of the components of the coating composition occurs to form a coating. The coating composition may also be subjected to curing conditions such that a substantially complete cure is attained and wherein further curing results in no significant further improvement in the coating properties such as, for example, resistance to solvent or hardness.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (23° C.). The reaction may be reversed under suitable conditions, such as at elevated temperatures, such as, e.g., between 90° C. and 200° C., such that the previously blocked isocyanato groups on the polyisocyanate curing agent are unblocked and available to react with the reactive groups, such as active hydrogen groups, of the cationic salt group-containing film-forming polymer to effectuate cure of the coating composition to form a coating.

As used herein, a “blocking agent” refers to a compound comprising a functional group reactive with an isocyanato group resulting in a blocked isocyanate. As used herein, a “blocking group” refers to the bound residual moiety of a blocking agent to the isocyanato group in the blocked polyisocyanate.

Blocking agents that are disassociated from the blocked polyisocyanate curing agent during cure may be removed from the coating film by volatilization. Alternatively, a portion or all of the blocking agent may remain in the coating film following cure.

Non-limiting examples of blocked polyisocyanates curing agents, and amounts thereof, including suitable polyisocyanates, and blocking components such as blocking groups and/or blocking agents, such as but not limited to 1,2 polyols, are provided in Int'l Pub. No. WO 2021/138583 A1, at paragraphs [0022] to [0035], the cited portion of which is incorporated herein by reference.

Non-limiting examples of blocked polyisocyanates comprising a blocking group derived from a blocking agent comprising an alpha-hydroxy amide, ester, or thioester and, optionally, a second blocking agent, are provided in Int'l Pub. No. WO 2018/148306 A1, at paragraphs [0010] to [0029], the cited portion of which is incorporated herein by reference. The blocked polyisocyanate may be a fully blocked polyisocyanate wherein essentially 100% of the isocyanato groups of the polyisocyanate are blocked with one or more blocking groups. Optionally, the blocked polyisocyanate curing agent may be an at least partially blocked polyisocyanate, having fewer than 100% of the isocyanato groups blocked, as long as the coating composition remains a stable dispersion, as defined herein.

The at least partially blocked polyisocyanate may be partially blocked with one or more of the blocking groups discussed above with the remaining isocyanato groups reacted with the polymer backbone, such as described in U.S. Pat. No. 3,947,338, at col. 2, line 65 through col. 5, line 33, the cited portion of which is herein incorporated by reference.

The blocked polyisocyanate curing agent may comprise a tris(alkoxycarbonylamino)-1,3,5-triazine (TACT). Non-limiting examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The curing agent may comprise an aminoplast or a phenoplast resin. Aminoplast resins are condensation products of an aldehyde with an amino- or amido-group carrying substance. Phenoplast resins are formed by the condensation of an aldehyde and a phenol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins, and amounts thereof, also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Suitable aminoplast and phenoplast resins also are described in U.S. Pat. No. 4,812,215 at col.6, line 20 to col. 7, line 12, the cited portion of which being incorporated herein by reference.

Non-limiting examples of inorganic curing agents include silicone-based curing agents. Non-limiting examples of such curing agents are described in Int'l Pub. No. WO 2021/138384 A1, at paragraphs [0030] through [0043], the cited portion of which is incorporated herein by reference.

The curing agent may be present in the electrodepositable coating composition, in an amount of at least 10% by weight, such as at least 20% by weight, such as at least 25% by weight, based on the total weight of the resin solids of the electrodepositable coating composition. The curing agent may be present in the electrodepositable coating composition, in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition, in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

The electrodepositable coating composition further comprises a curing catalyst. As used herein, the term “curing catalyst” is used interchangeably with “catalyst” and refers to materials that catalyze the curing reaction between components of the electrodepositable coating composition, such as, for example, the curing agent and film-forming polymers. For example, the catalyst may catalyze transurethanation reactions, and specifically catalyze the deblocking of blocked polyisocyanate blocking groups.

Non-limiting examples of curing catalysts include amine-containing compounds; compounds or complexes of metals such as bismuth, cerium, zinc, and/or titanium; and combinations thereof.

Catalysts suitable for cationic electrodepositable coating compositions include, without limitation, metal oxides (e.g., oxides of cerium, zirconium and bismuth) and salts thereof; zinc compounds or complexes; and/or a cyclic guanidine as described in U.S. Pat. No. 7,842,762 at col. 1, line 53 to col. 4, line 18 and col. 16, line 62 to col. 19, line 8, the cited portions of which being incorporated herein by reference.

Catalysts suitable for anionic electrodepositable coating compositions include, without limitation, latent acid catalysts. Latent acid catalysts are derivatives of acid catalysts that are generally activated by heating. Non-limiting examples of latent acid catalysts are identified in WO 2007/118024 at paragraph [0031]. Further examples of suitable latent acid catalysts include derivatives of acid catalysts such as sulfonic acids, such as derivatives of para-toluenesulfonic acid, such as pyridinium para-toluenesulfonate.

The amine-containing curing catalyst may comprise any suitable amine-containing curing catalyst, such as, but not limited to, curing catalysts comprising a guanidine, an imidazole, an amidine, and/or derivatives or combinations thereof.

Non-limiting examples of suitable guanidine curing catalysts are provided in Int'l Pub. No. WO 2018/0172519 A1, at paragraphs [0039] to [0050], the cited portion of which is incorporated herein by reference.

Non-limiting examples of imidazole curing catalysts are described in US Pub. No. 2022/0154014 A1, as paragraphs [0062] to [0108], the cited portion of which is incorporated herein by reference.

The amidine curing catalyst may, in a non-limiting example, comprise 1,8-diazabicyclo[5.4.0]undec-7-ene (DBU).

The zinc-containing catalyst may comprise a metal salt and/or complex of zinc such as, but not limited to, a zinc (11) amidine complex, zinc octoate, zinc naphthenate, zinc tallate, zinc carboxylates having from 8 to 14 carbons in the carboxylate group, zinc acetate, zinc sulfonates, zinc methanesulfonates, or any combination thereof. The zinc (II) amidine complex may contain amidine and carboxylate ligands.

The curing catalyst may be present in the electrodepositable coating composition in any suitable amount. For example, the amine and/or the zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine and/or zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine and/or zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The curing catalyst may comprise a bismuth catalyst. Non-limiting examples of bismuth curing catalysts, and amounts thereof, are provided in Int'l Pub. No. WO 2021/138583 A1, at paragraphs [0036] to [0050], the cited portion of which is incorporated by reference.

The curing catalyst may comprise a titanium compound and/or complex such as, for example, Ti(OR¹)₄, wherein R¹ is an alkyl or aryl, such as wherein R¹ is a C3-C20 alkyl, such as wherein R¹ is n-butyl, such as tetrabutyl titanate.

The electrodepositable coating composition may be substantially free, essentially free, or completely free of catalytic tin. The electrodepositable coating composition may be substantially free, essentially free, or completely free of catalytic tin. As used herein, the electrodepositable coating composition is “substantially free” of catalytic tin if catalytic tin is present in an amount of less than 0.1% by weight, based on the total weight of the electrodepositable coating composition. As used herein, the electrodepositable coating composition is “essentially free” of catalytic tin if catalytic tin is present in an amount of less than 0.01%, based on the total weight of the electrodepositable coating composition. As used herein, the electrodepositable coating composition is “completely free” of catalytic tin if catalytic tin is present in an amount of 0.001%, based on the total weight of the electrodepositable coating composition.

The electrodepositable coating composition may further comprise a pigment. Non-limiting examples of pigment include, for example, iron oxides, lead oxides, strontium chromate, carbon black, coal dust, titanium dioxide, talc, barium sulfate, thermally conductive, electrically insulative filler materials, thermally conductive, electrically conductive filler materials, non-thermally conductive, electrically insulative filler materials, fire-retardant pigments, as well as color pigments such as cadmium yellow, cadmium red, chromium yellow and the like.

The pigment may comprise a plate-like pigment, such as an inorganic plate-like pigment.

The plate-like pigment may be a phyllosilicate pigment. As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments include the micas, chlorites, serpentine, talc, and the clay minerals. The clay minerals include, for example, kaolin clay. The sheet-like structure of the phyllosilicate pigment tends to result in pigment having a plate-like structure, although the pigment can be manipulated (such as through mechanical means) to have other particle structures. These pigments when exposed to liquid media may or may not swell and may or may not have leachable components (e.g., ions that may be drawn towards the liquid media).

The plate-like pigment may comprise a plate-like mica pigment, a plate-like chlorite pigment, a plate-like serpentine pigment, a plate-like talc pigment, and/or a plate-like clay pigment. The plate-like clay pigment may comprise kaolin clay, or a combination thereof.

The pigment component may comprise a plate-like pigment having an average equivalent spherical diameter of at least 50 nm and up to 25 microns or higher. The average equivalent spherical diameter may be determined using dynamic light scattering, such as with a SEDIGRAPH III PLUS particle size analyzer, available from Micromeritics Instrument Corp. As plate-like particles the pigment often has substantially opposing surfaces and particles typically exhibit an aspect ratio of the longest axis to the shortest axis of, for example, at least 2:1, such as at least 4:1, such as at least 6:1, such as at least 8:1, such as at least 10:1 or higher. For example, the plate-like pigment may have an average equivalent spherical diameter of at least 50 nm, such as at least 0.2 microns, such as at least 0.4 microns, such as at least 0.6 microns, such as at least 1 micron, such as at least 2 microns, such as at least 3 microns, such as at least 4 microns, such as at least 5 microns. The plate-like pigment may have an average equivalent spherical diameter of no more than 25 microns, such as no more than 15 microns, such as no more than 10 microns, such as no more than 5 microns, such as no more than 3.5 microns, such as no more than 2.5 microns, such as no more than 1.9 microns, such as no more than 1.5 microns, such as no more than 1 microns.

As used herein, “fire-retardant” refers to a material that slows down or stops the spread of fire or reduces its intensity. Fire retardants may be available as a powder that may be mixed with a composition, a foam, or a gel. In examples, when the cationic electrodepositable coating compositions include a fire-retardant, such compositions may form a coating on a substrate surface and such coating may function as a fire-retardant coating.

As set forth in more detail below, a fire-retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated fire retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of fire retardants, compounds contain both phosphorus and a halogen. Such compounds include tris(2,3-dibromopropyl)phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable fire retardants include ammonium polyphosphate and barium sulfate.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film.

The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.4:1, such as at least 0.5:1, such as at least 0.6:1, such as at least 0.67, such as at least 0.7:1, such as at least 0.75:1, such as at least 1:1, such as at least 1.25:1, such as at least 1.5:1. The pigment-to-binder (P:B) ratio of the pigment to the electrodepositable binder may be no more than 2:1, such as no more than 1.75:1, such no more than 1.5:1, such as no more than 1.25:1, such as no more than 1:1, such as no more than 0.75:1, such as no more than 0.7:1, such as no more than 0.6:1, such as no more than 0.55:1, such as no more than 0.5:1, such as no more than 0.25:1. The pigment-to-binder (P:B) ratio of the pigment to the electrodepositable binder may be 0.05:1 to 2:1, such as 0.05:1 to 1:1, such as 0.05:1 to 0.75:1, such as 0.05:1 to 0.7:1, such as 0.05:1 to 0.6:1, such as 0.05:1 to 0.55:1, such as 0.05:1 to 0.5:1, such as 0.05 to 0.25:1, such as 0.1:1 to 2:1, such as 0.1:1 to 1:1, such as 0.1:1 to 0.75:1, such as 0.1:1 to 0.7:1, such as 0.1:1 to 0.6:1, such as 0.1:1 to 0.55:1, such as 0.1:1 to 0.5:1, such as 0.1:1 to 0.25:1, such as 0.2:1 to 2:1, such as 0.2:1 to 1:1, such as 0.2:1 to 0.75:1, such as 0.2:1 to 0.7:1, such as 0.2:1 to 0.6:1, such as 0.2:1 to 0.55:1, such as 0.2:1 to 0.5:1, such as 0.2:1 to 0.25:1, such as 0.3:1 to 2:1, 0.3:1 to 1:1, such as 0.3:1 to 0.75:1, such as 0.3:1 to 0.7:1, such as 0.3:1 to 0.6:1, such as 0.3:1 to 0.55:1, such as 0.3:1 to 0.5:1, such as 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.67:1 to 2:1, such as 0.67:1 to 1.75:1, such as 0.67:1 to 1.5:1, such as 0.67:1 to 1.25:1, such as 0.67:1 to 1:1, such as 0.67:1 to 0.75:1, such as 0.67:1 to 0.7:1, such as 0.7:1 to 2:1, such as 0.7:1 to 1.75:1, such as 0.7:1 to 1.5:1, such as 0.7:1 to 1.25:1, such as 0.7:1 to 1:1, such as 0.7:1 to 0.75:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

The pigment-to-binder (P:B) ratio of the inorganic plate-like pigment to the electrodepositable binder may be at least 0.4:1, such as at least 0.5:1, such as at least 0.6:1, such as at least 0.7:1, such as at least 0.75:1, such as at least 1:1, such as at least 1.25:1, such as at least 1.5:1. The pigment-to-binder (P:B) ratio of the inorganic plate-like pigment to the electrodepositable binder may be no more than 2:1, such as no more than 1.75:1, such no more than 1.5:1, such as no more than 1.25:1, such as no more than 1:1, such as no more than 0.75:1, such as no more than 0.7:1, such as no more than 0.6:1, such as no more than 0.55:1, such as no more than 0.5:1. The pigment-to-binder (P:B) ratio of the inorganic plate-like pigment to the electrodepositable binder may be 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.7:1 to 2:1, such as 0.7:1 to 1.75:1, such as 0.7:1 to 1.5:1, such as 0.7:1 to 1.25:1, such as 0.7:1 to 1:1, such as 0.7:1 to 0.75:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

The electrodepositable coating composition may optionally comprise a dispersing agent to assist in dispersing the pigment and other optional filler materials.

The electrodepositable compositions may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodepositable coating composition in an amount of at least 0.001% by weight, such as at least 5% by weight, based on the total weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodepositable coating composition.

Alternatively, the electrodepositable coating composition may be substantially free, essentially free, or completely free of a corrosion inhibitor.

According to the present disclosure, the electrodepositable coating composition may comprise other optional ingredients, such as if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Each of the optional other ingredients mentioned above may be present in the electrodepositable coating composition in amounts of 0.01% to 3% by weight, based on total weight of the resin solids of the electrodepositable coating composition. Alternatively, the electrodepositable coating composition may be completely free of any of the optional ingredients, i.e., the optional ingredient is not present in the electrodepositable coating composition.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

According to the present disclosure, a coating deposited from the electrodepositable coating composition may be electrophoretically applied onto an electrically conductive substrate. The electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091, all of which are incorporated herein by reference.

In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

In examples, the substrate may comprise a battery or battery component. The battery component may comprise, but is not limited thereto, a battery cell, a battery shell, a battery module, a battery pack, a battery box, a battery cell casing, a pack shell, a battery lid and tray, a thermal management system, a battery housing, a module housing, a module racking, a battery side plate, a battery cell enclosure, a cooling module, a cooling tube, a cooling fin, a cooling plate, a bus bar, a battery frame, an electrical connection, metal wires, or copper or aluminum conductors or cables. The battery may be, for example, an electric vehicle battery, and the battery component may be, for example, an electric vehicle battery component.

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component so long as the three-dimensional component is electroconductive.

According to the present disclosure, the cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

The present disclosure is also directed to a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as a cathode in electrical communication with an anode immersed in the cationic electrodepositable coating composition; (2) allowing the immersed metal substrate to dwell in the cationic electrodepositable coating composition for a period of time, whereby a metal phosphate layer forms over at least a portion of the surface of the metal substrate; and (3) applying a direct electrical current between the cathode and the anode whereby a coating is deposited onto the surface of the metal substrate from the cationic electrodepositable coating composition.

The dwell time may be at least 10 seconds, such as at least 30 seconds, such as at least 1 minute, such as at least 4 minutes, such as at least 5 minutes, such as at least 8 minutes, such as at least 10 minutes, such as at least 12 minutes, such as at least 15 minutes, or longer. The dwell time may also be less than 15 minutes, less than 12 minutes, less than 10 minutes, less than 8 minutes, less than 5 minutes, less than 4 minutes, less than 1 minute, or less than 30 seconds. The dwell time may be 10 seconds to 15 minutes, such as 10 seconds to 12 minutes, such as 10 seconds to 10 minutes, such as 10 seconds to 8 minutes, such as 10 seconds to 5 minutes, such as 10 seconds to 4 minutes, such as 10 seconds to 1 minute, such as 10 seconds to 30 seconds. As mentioned above, the dwelling of the substrate results in the production of a metal phosphate layer over at least a portion of the surface of the metal substrate such that dwelling in the electrodepositable coating composition serves as a pseudo-pretreatment composition application. As used herein, “pretreatment composition” refers to a composition that is capable of reacting with and chemically altering the substrate surface and binding to it to form a film/layer.

Optionally, the metal substrate is not treated with a pretreatment composition, such as a zinc-phosphate or zirconium-containing pretreatment composition, prior to being immersed in the cationic electrodepositable coating composition.

Following the substrate dwelling in the cationic electrodepositable coating composition for a period of time, a direct electrical current is impressed between the electrodes to deposit a coating from the cationic electrodepositable coating composition onto the surface of the metal substrate by a procedure typical in the art, such as the conditions described above (e.g., voltage, current density, time, etc.).

The present disclosure is also directed to a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as an electrode in electrical communication with a counter-electrode immersed in the cationic electrodepositable coating composition; (2) applying a direct electrical current between the electrode and the counter-electrode wherein the electrode serves as the anode and the counter-electrode serves as the cathode, whereby a metal phosphate layer forms over at least a portion of the surface of the metal substrate; and (3) applying a direct electrical current between the electrode and the counter-electrode wherein the polarity is reversed and the electrode serves as the cathode and the counter-electrode serves as the anode, whereby a coating is deposited onto the surface of the metal substrate from the cationic electrodepositable coating composition.

The direct electrical current applied in part (2) of the method is the reverse polarity to the direct electrical current applied when depositing a coating from the electrodepositable coating composition. The applied voltage may be varied and can be, for example, as low as 1.5 volts to as high as 20 volts, such as between 5 and 15 volts, the current density may be between 0.5 ampere and 15 amperes per square foot, and the time that the current is applied may be varied and can be, for example, at least 1 minutes, such as at least 2 minutes, such as at least 4 minutes, or higher.

Optionally, the metal substrate is not treated with a pretreatment composition, such as a zinc-phosphate or zirconium-containing pretreatment composition, prior to being immersed in the cationic electrodepositable coating composition.

Following the application of the reverse polarity direct electrical current, a direct electrical current is impressed between the electrodes to deposit a coating from the cationic electrodepositable coating composition onto the surface of the metal substrate by a procedure typical in the art, such as the conditions described above (e.g., voltage, current density, time, etc.).

Without intending to be bound by theory, it is believed that the dwelling of the substrate or application of a reverse-polarity electrical current prior to electrodepositing a coating from the electrodepositable coating composition allows the phosphate ions or polymer comprising at least one phosphorylated group to interact with the surface of the metal substrate to produce a metal phosphate layer over at least a portion of the substrate surface. This may allow for elimination of pretreatment steps prior to electrocoating the substrate, such as elimination treating the substrate with a zinc phosphate, iron phosphate, or zirconium containing pretreatment composition.

The present disclosure is also directed to a method of coating a metal substrate comprising: (1) immersing a surface to be coated of the metal substrate into a cationic electrodepositable coating composition comprising: (a) a cationic-salt group-containing, film-forming polymer; (b) a curing agent; and (c) a source of phosphate ions or a polymer comprising at least one phosphorylated group, wherein the metal substrate serves as an electrode in electrical communication with a counter-electrode immersed in the cationic electrodepositable coating composition; and (2) applying a direct electrical current between the electrode and the counter-electrode whereby a coating is deposited onto the surface of the metal substrate from the cationic electrodepositable coating composition; wherein the metal substrate is not treated with a pretreatment composition prior to being immersed in the cationic electrodepositable coating composition.

The metal substrate to be coated optionally may first be cleaned to remove grease, dirt, or other extraneous matter. Conventional cleaning procedures and materials may be employed. These materials could include, for example, mild or strong alkaline cleaners, such as those that are commercially available. The application of such cleaners may be followed and/or preceded by a water rinse.

The metal surface optionally may then be rinsed with an aqueous acidic solution after cleaning with the alkaline cleaner. Examples of suitable rinse solutions include mild or strong acidic cleaners, such as the dilute nitric acid solutions commercially available.

Following application of a coating from the cationic electrodepositable coating composition, the method may optionally further comprise applying additional coating compositions to form one or more suitable topcoat coating layer(s) over the electrodeposited coating layer (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, one or more of the topcoat layers may be applied onto a substantially uncured underlying layer. For example, a clear coat layer may be applied onto at least a portion of a substantially uncured basecoat layer (wet-on-wet), and both layers may be simultaneously cured in a downstream process.

As noted above, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of a multi-layer coating composite in any amount sufficient to impart the desired property, visual and/or color effect.

The present disclosure is further directed to a coating formed by at least partially curing a film deposited from the electrodepositable coating composition described herein.

The present disclosure is further directed to a coated substrate coated with a coating deposited from the cationic electrodepositable coating composition described herein. Further, the coated substrate optionally may be coated by any of the methods described herein.

The coated substrate optionally may not include a pretreatment layer between the substrate and the coating deposited from the cationic electrodepositable coating composition.

The coated conductive substrate optionally may not include any intervening coating layers between the substrate and the coating deposited from the cationic electrodepositable coating composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. Nevertheless, they also include the more restrictive terms “consisting of” and “consisting essentially of. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “a” cationic-salt group-containing, aromatic film-forming polymer, “an” cationic salt group-containing film-forming polymer, “an” addition polymer, “a” polymer comprising at least phosphorylated groups, “a” monomer, “a” curing agent, “a” pigment, and “an” inorganic, plate-like pigment, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### Examples

Preparation of Crosslinker 1. A blocked polyisocyanate crosslinker, suitable for use in electrodepositable coating compositions, was prepared in the following manner. Components 2-3 listed in Table 1, below, were mixed in a flask set up for total reflux with stirring under nitrogen. The mixture was heated to a temperature of 110° C., and Component 1 was added dropwise so that the temperature increased due to the reaction exotherm and was maintained under 110° C. After the addition of Component 1 was complete, Component 4 was added to the heated reaction mixture. A temperature of 110° C. was established in the reaction mixture and the reaction mixture held at temperature until no residual isocyanate was detected by IR spectroscopy. Components 5 and 6 were then added, and the reaction mixture was allowed to stir for 30 minutes and cooled to ambient temperature.

TABLE 1
Components for the preparation of Crosslinker 1

| | | Parts-by- |
|---|---|---|
| No. | Component | weight (grams) |
| 1 | Polymeric methylene diphenyl diisocyanate¹ | 2593 |
| 2 | Dibutyl tin dilaurate | 2.7 |
| 3 | Dowanol DPM² | 2868 |
| 4 | Bisphenol A - ethylene oxide adduct | 233 |
| | (⅙ molar ratio BPA/EtO) | |
| 5 | Butyl carbitol formal | 21 |
| 6 | Dowanol PM (1-methoxy-2-propanol)³ | 286 |

¹Rubinate M, available from Huntsman Corporation
²Dipropylene glycol monomethyl ether available from Dow
³1-methoxy-2-propanol available from Dow

Preparation of Crosslinker 2. A blocked polyisocyanate crosslinker, suitable for use in electrodepositable coating compositions, was prepared in the following manner. Components 2-4 listed in Table 2, below, were mixed in a flask set up for total reflux with stirring under nitrogen. The mixture was heated to a temperature of 110° C., and Component 1 was added dropwise so that the temperature increased due to the reaction exotherm and was maintained under 110° C. After the addition of Component 1 was complete, Component 5 was added to the heated reaction mixture. A temperature of 110° C. was established in the reaction mixture and the reaction mixture held at temperature until no residual isocyanate was detected by IR spectroscopy. Components 6 and 7 were then added, and the reaction mixture was allowed to stir for 30 minutes and cooled to ambient temperature.

TABLE 2
Components for the preparation of Crosslinker 2

| | | Parts-by- |
|---|---|---|
| No. | Component | weight (grams) |
| 1 | Polymeric methylene diphenyl diisocyanate¹ | 1340 |
| 2 | Dibutyl tin dilaurate | 1.5 |
| 3 | Triethylene glycol monomethyl ether | 1149 |
| 4 | Polyethylene glycol 400 | 600 |
| 5 | Butyl carbitol formal | 12 |
| 6 | Dowanol PM (1-methoxy-2-propanol)² | 162 |
| 7 | Bisphenol A - ethylene oxide adduct | 132 |
| | (⅙ molar ratio BPA/EtO) | |

¹Rubinate M, available from Huntsman Corporation
²1-methoxy-2-propanol available from Dow

Preparation of a Cationic, Amine-Functionalized, Polyepoxide-Based Resin (Resin 1). A cationic, amine-functionalized, polyepoxide-based polymeric resin, suitable for use in formulating electrodepositable coating compositions, was prepared in the following manner. Components 1-4 listed in Table 3, below, were combined in a flask set up for total reflux with stirring under nitrogen. The mixture was heated to a temperature of 130° C. and allowed to exotherm (170° C. maximum). A temperature of 145° C. was established in the reaction mixture and the reaction mixture was then held for 1.5 hours. Components 5-6 were then introduced into the reaction mixture and a temperature of 100° C. was established in the reaction mixture. Components 7 and 8 were then added to the reaction mixture quickly and the reaction mixture was allowed to exotherm. A temperature of 110° C. was established in the reaction mixture and the reaction mixture held for 1 hour. After the hold, the heating source was removed from the reaction mixture and Component 9 was introduced slowly. The content of the flask was allowed to stir while cooling to room temperature. The resulting Resin Synthesis Product I had a solids content of 86.9% by weight.

TABLE 3
Components for the preparation of Resin System 1

| | | Parts-by- |
|---|---|---|
| No. | Component | weight (grams) |
| 1 | Bisphenol A diglycidyl ether¹ | 188 |
| 2 | Bisphenol A | 81.2 |
| 3 | Bisphenol A - ethylene oxide adduct charge 1 | 80.0 |
| | (⅙ molar ratio BPA/EtO) | |
| 4 | Ethyl triphenyl phosphonium iodide | 0.183 |
| 5 | Bisphenol A - ethylene oxide adduct charge 2 | 18.6 |
| | (⅙ molar ratio BPA/EtO) | |
| 6 | Butyl carbitol formal | 8.50 |
| 7 | Aminopropyl diethanol amine | 6.60 |
| 8 | n-Methyl ethanol amine | 14.4 |
| 9 | Dowanol PM (1-methoxy-2-propanol)³ | 62.0 |

¹Epon 880, available from Hexion Corporation
2 See example Crosslinker 1 above
³1-methoxy-2-propanol available from Dow Chemical Company

Preparation of phosphated acrylic polyol polymers A and B: Component 1 listed in Table 4, below, was added to a flask set up for total reflux with stirring under nitrogen and heated to 120° C. Components 9 and 10 (initiator charge 1) were added to the flask dropwise over 3 hours and 35 minutes. Five minutes after initiator charge 1 was started, components 2-8 (monomer charge) were mixed in an addition funnel and added dropwise over 3.5 hours. Once the monomer charge was complete, charge 13 was used to rinse the monomer charge addition funnel. After both charges were completed, the reaction was held at 120° C. for 1 hour. Components 11 and 12 (initiator charge 2) were then added dropwise via addition funnel to the reaction flask over 30 min. After initiator charge 2 was complete, Component 14 was used to rinse the addition funnel. The reaction was held for 90 minutes at 120° C., and then allowed to cool to room temperature with stirring. The resulting phosphated acrylic polyol resin had a solids content of 56% by weight.

TABLE 4
Components for the preparation of phosphated
acrylic polyol polymers A and B

| | | Parts-by-weight (grams) | |
|---|---|---|---|
| No. | Component | Polymer A | Polymer B |
| 1 | Methyl isobutyl ketone | 750 | 688 |
| 2 | Isobornyl methacrylate¹ | 450 | 413 |
| 3 | Styrene² | 450 | 403 |
| 4 | 2-ethylhexyl acrylate³ | 180 | 165 |
| 5 | tert-dodecyl mercaptan⁴ | 10.8 | 9.90 |
| 6 | Sipomer ® PAM-100⁵ | 90.0 | — |
| | Sipomer ® PAM-200⁵ | — | 82.5 |
| 7 | 2-hydroxyethyl acrylate⁶ | 270 | 247.5 |
| 8 | Tone ™ M-201⁷ | 360 | 330 |
| 9 | tert-amyl peroxy-2-ethylhexanoate⁸ | 54.3 | 49.5 |
| 10 | Methyl isobutyl ketone | 410 | 376 |
| 11 | tert-amyl peroxy-2-ethylhexanoate⁸ | 5.4 | 5.00 |
| 12 | Methyl isobutyl ketone | 95.0 | 87.1 |
| 13 | Methyl isobutyl ketone | 50.0 | 45.8 |
| 14 | Methyl isobutyl ketone | 50.0 | 45.8 |

¹Sipomer ® Iboma from Solvay
²Styrene from Millipore Sigma
³2-ethylhexyl acrylate from Dow
⁴t-dodecyl mercaptan from Arkema
⁵Each of Sipomer ® PAM-100 and Sipomer ® PAM-200 are phosphoalkyl (meth)acrylates available from Solvay
⁶2-hydroxyethyl acrylate from BASF
⁷Hydroxyl-functional methacrylate monomer from Dow
⁸Luperox 575 from Arkema

Reference Electrocoat preparation: The reference electrodepositable coating composition was prepared in the following manner. Components 1-6 listed in Table 4a, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 7-8 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 9 was added to bring the final solids of this dispersed paste to 50% on weight. Component 10 was then added into the dispersed formulation and allowed to mix under ambient temperatures for one hour to complete the feed at high solids. To generate the electrocoat bath composition, the high solids feed was further diluted with Component 11 to 25% solids by weight.

TABLE 4a
Components for the preparation of Reference Electrocoat

| | | Parts-by- |
|---|---|---|
| No. | Component | weight (grams) |
| 1 | Plate-like pigment¹ | 417.6 |
| 2 | Crosslinker 1² | 274.4 |
| 3 | Resin 1³ | 447.1 |
| 4 | Bisphenol A - ethylene oxide adduct | 33.15 |
| | charge (⅙ molar ratio BPA/EtO) | |
| 5 | Phosphoric Acid (85%) | 6.35 |
| 6 | Deionized water | 76.20 |
| 7 | Sulfamic acid | 10.7 |
| 8 | Deionized water | 617.3 |
| 9 | Deionized water | 377 |
| 10 | E6278⁴ | 32.8 |
| 11 | Deionized water | 2,260 |

¹ASP200 clay available from BASF
²See example Crosslinker I above
³See example Resin System I above
⁴Dibutyltin dioxide paste available from PPG Industries Inc.

Electrocoat 1 preparation: The electrodepositable coating composition was prepared in the following manner. Components 1-6 listed in Table 4b, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 7-8 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 9 was added to bring the final solids of this dispersed paste to 50% on weight. Component 10 was then added into the dispersed formulation and allowed to mix under ambient temperatures for one hour to complete the feed at high solids. To generate the electrocoat bath composition, the high solids feed was further diluted with Component 11 to 25% solids by weight.

TABLE 4b
Components for the preparation of Electrocoat 1

| | | Parts-by- |
|---|---|---|
| No. | Component | weight (grams) |
| 1 | Plate-like pigment¹ | 417.6 |
| 2 | Crosslinker 1² | 261.9 |
| 3 | Resin 1³ | 447.1 |
| 4a | Bisphenol A - ethylene oxide adduct | 31.65 |
| | charge (⅙ molar ratio BPA/EtO) | |
| 4b | Phosphated acrylic polyol polymer A⁴ | 31.65 |
| 5 | Phosphoric Acid (85%) | 6.06 |
| 6 | Deionized water | 72.8 |
| 7 | Sulfamic acid | 10.2 |
| 8 | Deionized water | 620.6 |
| 9 | Deionized water | 376 |
| 10 | E6278⁵ | 32.25 |
| 11 | Deionized water | 2,258 |

¹ASP200 clay available from BASF
²See example Crosslinker I above
³See example Resin System I above
⁴See example Polymer A above
⁵Dibutyltin dioxide paste available from PPG Industries Inc.

Electrocoat 2 preparation: The electrodepositable coating composition was prepared in the following manner. Components 1-6 listed in Table 4c, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 7-8 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 9 was added to bring the final solids of this dispersed paste to 40% on weight. Component 10 was then added into the dispersed formulation and allowed to mix under ambient temperatures for one hour to complete the feed at high solids. To generate the electrocoat bath composition, the high solids feed was further diluted with Component 11 to 25% solids by weight.

TABLE 4c
Components for the preparation of Electrocoat 2

| No. | Component | Parts-by-weight (grams) |
|---|---|---|
| 1 | Plate-like pigment¹ | 417.6 |
| 2 | Crosslinker 2² | 330.6 |
| 3 | Resin 1³ | 389.3 |
| 4 | Phosphated acrylic polyol polymer A⁴ | 33.15 |
| 5 | Phosphoric Acid (85%) | 5.55 |
| 6 | Deionized water | 76.2 |
| 7 | Sulfamic acid | 9.3 |
| 8 | Deionized water | 993.5 |
| 9 | Deionized water | 563.8 |
| 10 | E6278⁵ | 32.8 |
| 11 | Deionized water | 1691 |

¹ASP200 clay available from BASF
²See example Crosslinker 2 above
³See example Resin System I above
⁴See example Polymer A above
⁵Dibutyltin dioxide paste available from PPG Industries Inc.

Evaluation of the compositions: Each test panel was submerged in the respective electrodepositable coating composition and electrodeposition was carried out using a rectifier (Xantrax Model XFR600-2, Elkhart, Indiana, or Sorensen XZG 300-5.6, Ameteck, Berwyn, Pennsylvania) which was DC-power supplied. Exact coating conditions and film builds for each paint are found provided in the table below. After the panels were electrocoated, each panel was rinsed with deionized water and baked at 177° C. in an electric oven (Despatch Model LFD-1-42).

| Condition | |
|---|---|
| Film build (mil) | 1.0 |
| Voltage (V) | 250 |
| Current (Amps) | 0.5 |
| Time (minutes) | 2 |
| Bake time (minutes) | 30 |

After baking, electrocoated panels were vertically scribed on one side of the panel down to the metal substrate. For corrosion performance evaluation, panels were placed in CASS (Copper Accelerated Acetic Acid Salt Spray) testing for a minimum of 21. At the end of the test, the panels were rated by measuring the paint loss from the scribe (creep) and the maximum creepage (both sides) calculated in millimeters for each panel. After the exposure, corroded panels were dried under ambient conditions. The loose coating around the scribe was removed by applying a scotch filament tape (3M Industries Adhesives and Tapes Divisions, St. Paul, MN) and pulling it off. The width of exposed metal region along the scribe was then recorded for 5 to 12 locations and averaged to assess the corrosion performance of the panel. As used herein, scribe creep refers to the area of paint loss around the scribe either through corrosion or disbondment (e.g., affected paint to affected paint). Panels for each condition were run in duplicate and results averaged. The results show an improved scribe creep for the electrodepositable coating compositions that included the phosphated acrylic polyol polymer and are included in Table 5 below.

TABLE 5
Impact of Phosphated Polyol on Electrocoat formulation

Corrosion Al
CASS 21 days
Scribe Creep (mm)

| Base | | | C710 | |
|---|---|---|---|---|
| Formulation | Polymer | X-linker | C59 | CKSP1R |
| Reference | No | Crosslinker 1 | 15.1 | 9 |
| Ecoat | | | | |
| Ecoat 1 | Polymer | Crosslinker 1 | 4.7 | 6.1 |
| | A | | | |
| Ecoat 2 | Polymer | Crosslinker 2 | 5.3 | 6.9 |
| | A | | | |

Preparation of a Cationic, Amine-Functionalized, Polyepoxide-Based Resin (Resin System 2). A cationic, amine-functionalized, polyepoxide-based polymeric resin, suitable for use in formulating electrodepositable coating compositions, was prepared in the following manner. Components 1-4 listed in Table 6, below, were combined in a flask set up for total reflux with stirring under nitrogen. The mixture was heated to a temperature of 130° C. and allowed to exotherm (170° C. maximum). A temperature of 145° C. was established in the reaction mixture and the reaction mixture was then held for 1.5 hours. Components 5-7 were then introduced into the reaction mixture and a temperature of 100° C. was established in the reaction mixture. Components 8 and 9 were then added to the reaction mixture quickly and the reaction mixture was allowed to exotherm. A temperature of 110° C. was established in the reaction mixture and the reaction mixture held for 1 hour. After the hold, the heating source was removed from the reaction mixture and Component 10 was introduced slowly. The content of the flask was allowed to stir while cooling to room temperature. The resulting Resin Synthesis Product 2 had a solids content of 87.6% by weight.

TABLE 6
Components for the preparation of Resin System 2

| | | Parts-by-weight |
|---|---|---|
| No. | Component | (grams) |
| 1 | Bisphenol A diglycidyl ether¹ | 614.7 |
| 2 | Bisphenol A | 265.4 |
| 3 | Bisphenol A - ethylene oxide adduct charge 1 | 100 |
| | (1/6 molar ratio BPA/EtO) | |
| 4 | Ethyl triphenyl phosphonium iodide | 0.6 |
| 5 | Bisphenol A - ethylene oxide adduct charge 2 | 139.7 |
| | (1/6 molar ratio BPA/EtO) | |
| 6 | Crosslinker 1² | 1234.3 |
| 7 | Butyl carbitol formal | 112 |
| 8 | Aminopropyl diethanol amine | 21.7 |
| 9 | n-Methyl ethanol amine | 47.0 |
| 10 | Dowanol PM (1-methoxy-2-propanol)³ | 292.1 |

¹Epon 880, available from Hexion Corporation
²See example Crosslinker 1 above.
³1-methoxy-2-propanol available from Dow Chemical Company

Preparation of electrodepositable coating composition: The electrodepositable coating compositions (Electrocoat Formulation A and Electrocoat Formulation B) were prepared in the following manner. Components 1-5 listed in Table 7, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 6-7 was added to the clay/Resin System I paste. A temperature of less than 60° C. was established and the dispersion was mixed with a high-lift blade at 1500 RPM for one hour. After dispersing, the dispersion was allowed to cool to ambient temperatures and Component 8 was added. Component 9 was then added into the dispersed formulation and allowed to mix under ambient temperatures for one hour to complete the feed at high solids. To generate the electrocoat bath composition, the high solids feed was further diluted with Components 10-12.

TABLE 7
Components for the preparation of Reference Electrocoat

| | | |
|---|---|---|
| Electrocoat | A | B |

| | | |
|---|---|---|
| | Formulation | Parts-by-weight |
| No. | Component | (grams) |

| | | | |
|---|---|---|---|
| 1 | Resin 3¹ | 660 | 660 |
| 2 | Phosphated Acrylic | 0 | 51.4 |
| | Polymer A² | | |
| 3 | Plate-like pigment³ | 347 | 363.8 |
| 4 | Phosphoric Acid | 4.81 | 4.7 |
| | (85%) | | |
| 5 | Deionized water | 66.5 | 66.4 |
| 6 | Sulfamic acid | 8.11 | 8.56 |
| 7 | Deionized water | 886.4 | 914 |
| 8 | Deionized water | 369.9 | 387.9 |
| 9 | E6278⁴ | 27.5 | 28.76 |
| 10 | Deionized water | 780 | 1474.1 |
| 11 | Phosphoric Acid | 9.75 | 0 |
| | (85%) | | |
| 12 | Hydroxylamine | 0.78 | 0 |
| | sulfate⁵ | | |

¹See example Resin System 3 above
²See example Polymer A above
³ASP200 clay available from BASF
⁴Dibutyltin dioxide paste available from PPG Industries Inc.
⁵Hydroxylamine sulfate available from Fisher Scientific

### Evaluations of Dwell Time and Electrodeposited Coatings

CRS panels as described above were allowed to dwell in the electrodepositable coating compositions prior to electrodepositing a coating layer. Coating conditions for electrocoat formulation A on flat steel are provided below in Table 8.

TABLE 8
Coating Conditions and Thickness for Flat Panels

| | Dwell Time | | | | |
|---|---|---|---|---|---|
| | Prior to | | | | |
| Electrocoat | Applying | | | | |
| Formulation | Voltage | | Temperature (F.) | Voltage | Coulombs |
| A | 15 | min | 110 | 200 V | 35 |
| A | <0.5 | min | 110 | 200 V | 35 |

To quantify if a phosphate layer had been spontaneously deposited from the electrodepositable coating composition prior to electrodepositing a coating, XRF measurements were taken of the CRS panels after dwelling in the electrodepositable coating composition. For XRF Panels, the samples were immersed for the specified time and then rinsed with deionized water and dried. XRF measurements, below in Table 9, were made utilizing Hitachi X-MET 7500 and measuring count number at 2.01 kEV after 30 seconds corresponding to the phosphorus Ka peak.

TABLE 9
XRF Measurements

| Electrocoat | Dwell Time Prior to | Counts |
|---|---|---|
| Formulation | Applying Voltage | (2 kEV) |
| None - bare substrate | None | 103 |
| A | 15 min | 312 |

The increase in XRF counts from dwelling the CRS panels in the electrodepositable coating composition compared to the bare CRS control indicates that dwelling the substrate causes a phosphorous layer to develop on the substrate surface.

The electrocoated test panels from Table 8 with and without extended dwell times prior to electrocoating the substrate were evaluated after 500 hours neutral salt fog exposure by measurements of scribe creep from end to end. At the end of the test, the panels were rated by measuring the paint loss from the scribe (creep) and the maximum creepage (both sides) calculated in millimeters for each panel. After the exposure, corroded panels were dried under ambient conditions. The loose coating around the scribe was removed by applying a scotch filament tape (3M Industries Adhesives and Tapes Divisions, St. Paul, MN) and pulling it off. The width of exposed metal region along the scribe was then recorded for 5 to 12 locations and averaged to assess the corrosion performance of the panel. As used herein, scribe creep refers to the area of paint loss around the scribe either through corrosion or disbondment (e.g., affected paint to affected paint). Panels for each condition were run in duplicate and results averaged. A significant reduction in scribe creep is observed with the extended dwell time prior to electrocoating compared to immediately electrocoating the substrate with formulation A.

TABLE 10
500-hour ASTM B117 Scribe Corrosion

| Electrocoat | Dwell Time Prior to | |
|---|---|---|
| Formulation | Applying Voltage | Scribe Creep (end to end) |
| A | 15 min | 4.5 mm |
| A | 0 min | 10 mm |

In order to see the effect on a high surface area substrate, Electrocoat Formulation A was electrocoated onto 4×6 Blasted Panels profiled to 2.0±0.5 mils (ACT item number 56225) according to the conditions in Table 11. Samples were allowed to dwell in the electrodepositable coating composition prior to applying voltage for a certain period of time and then voltage was applied to electrocoat the part.

TABLE 11
Coating Conditions and Thickness for Blasted Panels

| Electrocoat | Dwell Time Prior to | Temperature | | Time with |
|---|---|---|---|---|
| Formulation | Applying Voltage | (F.) | Voltage | Voltage |
| A | 15 min | 110 | 285 V | 180 s |
| A | 0 min | 110 | 285 V | 180 s |

For characterizing face corrosion, a 1-5 scale was used with 1 corresponding to 75-100% corrosion, 2 corresponding to 50-75% corrosion, 3 to 25-50% corrosion, 4 to 10-25% corrosion, and 5 to <10% corrosion. Samples were subjected to neutral salt spray for 504 hours. As seen below in Table 12, electrocoat formulation A with the immersion step has greatly reduced face corrosion compared to electrocoat alone.

TABLE 12
Neutral Salt Spray ASTM B117 504 Hour Face Corrosion

| Electrocoat | Dwell Time Prior to | B117 500 Hour Face |
|---|---|---|
| Formulation | Applying Voltage | Corrosion |
| A | 15 min | 5 |
| A | 0 min | 2 |

### Evaluations of Reverse-Polarity, Current-Assisted Deposition and Electrodeposited Coatings

In a current-assisted approach, CRS panels were immersed in the electrodepositable coating composition for a certain length of time while a low voltage, anodic current was applied. Table 13 below shows the XRF results after the CRS panels were immersed in Electrocoat Formulation A at 110F while applying 10 Volts for 4 minutes with the panel being the anode. XRF measurements were taken utilizing Hitachi X-MET 7500 and the count number at 2.01 kEV peak corresponding to the phosphorus Ka peak was measured (Table 13) after panels were rinsed with deionized water and dried.

TABLE 13
Current-assisted XRF Measurements

| Electrocoat | | Counts |
|---|---|---|
| Formulation | Dwell Conditions | (2 kEV) |
| None - bare substrate | None | 103 |
| A | 4 min anodic current-assist (10 Volts) | 264 |

A significant increase is observed in counts (phosphorus) for Electrocoat Formulation A compared to the CRS control panel. Additionally, the use of a low voltage, anodic current enabled the increase in phosphorous counts in a shorter amount of time compared to dwelling in the electrocoat formulation without a current.

In order to test the corrosion performance of the current assisted approach, 4×6 Blasted Panels profiled to 2.0±0.5 mils (ACT item number 56225) were dwelled in the electrodepositable coating composition with a low voltage anodic current to the part for a set amount of time. After the low voltage anodic current was applied to the part, a higher voltage cationic current (referred to as Cationic Voltage in following Tables) was applied to the part in the same electrodepositable coating composition to apply the coating. The exact conditions can be found in Table 14. The coatings were made to a thickness ranging from 40 percent to 50 percent of the blasted profile. As in example 1, a 1-5 corrosion scale was used. Samples were subjected to neutral salt spray for 504 hours. As seen below in Table 15, electrocoat formulation A with a current-assisted step has reduced face corrosion compared to electrocoating without the current assisted dwell prior to coating.

TABLE 14
Coating Conditions and Thickness for
Current-assisted Blasted Panels

| | Pre-Cationic | | | | |
|---|---|---|---|---|---|
| | Voltage Dwell | Temp. | Cationic | | Dry Film |
| E-coat | Conditions | (F.) | Voltage | Time | Thickness |
| A | None | 110 | 285 V | 180 s | 0.91 ± 0.15 |
| A | 4 min anodic current- | 110 | 285 V | 180 s | 0.86 ± 0.2 |
| | assist (10 Volts) | | | | |

TABLE 15
Neutral Salt Spray ASTM B117 504 Hour Face
Corrosion for Current-Assisted Panels

| | Pre-Cationic | |
|---|---|---|
| Electrocoat | Voltage Dwell | B117 500 Hour Face |
| Formulation | Conditions | Corrosion |
| A | 4 min anodic current-assist | 4 |
| | (10 Volts) | |
| A | None | 2 |

Evaluation of Phosphorylated Additive with Dwell Time or Current-Assisted Method

In addition to getting enhanced performance with phosphoric acid, a phosphate functional polymer was incorporated into the electrodepositable coating composition and panels were treated in the electrodepositable coating composition by either an immersion or current-assisted immersion process prior to applying the cationic current to coat the part. Blasted panel samples were prepared according to the conditions below in Table 16.

TABLE 16
Coating Conditions and Thickness

| | Pre-Cationic | | | | |
|---|---|---|---|---|---|
| Electrocoat | Voltage Dwell | Temperature | Cationic | | Dry Film |
| Formulation | Conditions | (F.) | Voltage | Time | Thickness |
| B | 15 min no | 100 | 275 V | 150 s | 1.00 ± |
| | current | | | | 0.11 |
| B | 4 min anodic | 100 | 275 V | 150 s | 1.03 ± |
| | current-assist | | | | 0.13 |
| | (10 V) | | | | |
| B | 0 min no | 100 | 275 V | 150 s | 1.02 ± |
| | current | | | | 0.15 |

As in example 1, a 1-5 corrosion scale was used. Samples were subjected to neutral salt spray for 504 hours. As seen below in Table 17, electrocoat formulation B with both current-assisted and immersion steps greatly reduces face corrosion compared to electrocoat alone.

TABLE 17
Neutral Salt Spray ASTM B117 504 Hour

| | Pre-Cationic | |
|---|---|---|
| Electrocoat | Voltage Dwell | B117 500 Hour Face |
| Formulation | Conditions | Corrosion |
| B | 4 min current-assist (10 V) | 4 |
| B | 15 min | 4 |
| B | None | 2 |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A cationic electrodepositable coating composition comprising:
a cationic-salt group-containing, aromatic film-forming polymer in amount of at least 10% by weight, based on the total weight of the resin solids;
an addition polymer comprising at least one phosphorylated group and optionally at least one hydroxyl functional group, wherein the addition polymer does not include a cationic or anionic-salt group when the addition polymer comprises a (meth)acrylamide monomer, and the addition polymer comprises less than 60% by weight of constitutional units comprising the residue of a hydroxyl-functional (meth)acrylate monomer and/or a hydroxyl-functional (meth)acrylamide monomer, based on the total weight of the addition polymer; and
a curing agent.

2. The cationic electrodepositable coating composition of claim 1, wherein the cationic-salt group-containing, aromatic film-forming polymer is at least partially derived from a diglycidyl ether of a bisphenol.

3. The cationic electrodepositable coating composition of claim 1, wherein the addition polymer comprises a polymerization product of a monomer composition comprising:
(a) a C₁-C₁₈ alkyl (meth)acrylate monomer; and
(b) a phosphorus acid-containing monomer.

4. (canceled)

5. The cationic electrodepositable coating composition of claim 3, wherein the monomer composition further comprises at least one of:
(c) a hydroxyl-functional (meth)acrylate monomer;
(d) a vinyl aromatic compound;
(e) a monomer comprising two or more ethylenically unsaturated groups per molecule;
(f) an alkyl (meth)acrylamide monomer; and/or
(g) a hydroxyl-functional (meth)acrylamide monomer.

6. The cationic electrodepositable coating composition of claim 1, further comprising:
a pigment, wherein the pigment-to-binder ratio is greater than 0.5:1.

7. The cationic electrodepositable coating composition of claim 1, wherein the addition polymer is present in an amount of 0.01% to 50% by weight, based on the total weight of resin solids in the cationic electrodepositable coating composition.

8. The cationic electrodepositable coating composition of claim 3, wherein the phosphorus acid-containing monomer is present in the monomer composition in an amount of 0.1% to 20% by weight, based on the total weight of the monomer composition.

9. The cationic electrodepositable coating composition of claim 1, wherein the addition polymer comprises hydroxyl functional groups and has a hydroxyl value of 1 to 500 mg KOH/g addition polymer.

10. The cationic electrodepositable coating composition of claim 1, wherein the addition polymer has a phosphorus acid equivalent weight of 0.01 to 10 milliequivalents per gram of addition polymer.

11. A cationic electrodepositable coating composition comprising:
a cationic-salt group-containing, film-forming polymer;
a phosphatized epoxy resin; and
a curing agent.

12. The cationic electrodepositable coating composition of claim 11, wherein the phosphatized epoxy resin is present in an amount of 0.01% to 50% by weight, based on the total weight of resin solids in the cationic electrodepositable coating composition.

13. The cationic electrodepositable coating composition of claim 11, wherein the phosphatized epoxy resin has a phosphorus acid equivalent weight of 0.01 to 10 milliequivalents per gram of phosphatized epoxy resin.

14. The cationic electrodepositable coating composition of claim 11, wherein the phosphatized epoxy resin has a hydroxyl value of 1 to 600 mg KOH/g.

15. A method of coating a metal substrate comprising:
(1) immersing a surface to be coated of the metal substrate into a cationic electrodepositable coating composition comprising:
(a) a cationic-salt group-containing, film-forming polymer;
(b) a curing agent; and
(c) a source of phosphate ions or a polymer comprising at least one phosphorylated group, wherein the metal substrate serves as a cathode in electrical communication with an anode immersed in the cationic electrodepositable coating composition;
(2) allowing the immersed metal substrate to dwell in the cationic electrodepositable coating composition for a period of time, whereby a metal phosphate layer forms over at least a portion of the surface of the metal substrate; and
(3) applying a direct electrical current between the cathode and the anode whereby a coating is deposited onto the surface of the metal substrate from the cationic electrodepositable coating composition.

16. The method of claim 15, wherein the metal substrate is not treated with a pretreatment composition prior to being immersed in the cationic electrodepositable coating composition.

17-19. (canceled)

20. The method of claim 15, wherein the cationic electrodepositable coating composition comprises a cationic-salt group-containing, aromatic film-forming polymer in amount of at least 10% by weight, based on the total weight of the resin solids, an addition polymer comprising at least one phosphorylated group and optionally at least one hydroxyl functional group, wherein the addition polymer does not include a cationic or anionic-salt group when the addition polymer comprises a (meth)acrylamide monomer, and the addition polymer comprises less than 60% by weight of constitutional units comprising the residue of a hydroxyl-functional (meth)acrylate monomer and/or a hydroxyl-functional (meth)acrylamide monomer, based on the total weight of the addition polymer, and a curing agent.

21. A coated substrate coated with a coating deposited from the electrodepositable coating composition of claim 1.

22. A coated substrate coated by the method of claim 15.
